(19) United States
(12) Patent Application Publication
(10) Pub. No.: US 2019/0166935 A1
(43) Pub. Date: Jun. 6, 2019

(54) SANITARY MASK

(71) Applicant: Zeppelin Corporation, Apia (WS)

(72) Inventor: Kuo-Ching Chiang, New Taipei City (TW)

(21) Appl. No.: 15/957,929

(22) Filed: Apr. 20, 2018

(30) Foreign Application Priority Data
Dec. 5, 2017 (TW) 106142586
Feb. 14, 2018 (TW) 107105481

(51) Int. Cl. A41D 31/00; B32B 27/08; B32B 27/20; B32B 27/30; B05D 1/18; B05D 3/02; A41D 13/11; A41H 42/00

(52) U.S. Cl. CPC A41D 31/0016; B32B 27/08; B32B 27/20; B32B 27/304; B05D 1/18; A41D 2400/26; A41D 13/1192; A41H 42/00; B32B 2307/71; B32B 2535/00; B05D 3/0254

(57) ABSTRACT

The present invention discloses a substrate for a sanitary mask, wherein the substrate is formed by Roll to Roll process and has anti-UV function. The process includes a step of mixing photochromic dye and resin.

### CROSS-REFERENCE TO RELATED APPLICATIONS

The present application claims the benefit of TAIWAN Patent Application Serial Number 106142586 and 107105481 respectfully filed on Dec. 5, 2017 and Feb. 14, 2018, which are herein incorporated by reference.

### TECHNICAL FIELD

The present invention relates to a mask, and particularly to a sanitary mask.

### BACKGROUND OF RELATED ARTS

Recently, the ultraviolet ray is extremely strong and thus affects the recovery after facial cosmetic surgery especially seriously. Currently, all of the sanitary masks on the market only have the function of filtering out dust only. However, the traditional mask is unable to filter PM 2.5 particles and fail to have anti-UV function.

### SUMMARY

The present invention relates to a sanitary mask with the following properties. The present invention discloses a sanitary mask, including: an inner layer; a middle layer disposed on the inner layer and including an ultra-micro-perforated filtering membrane; and an outer layer disposed on the middle layer.

In another aspect, a sanitary mask includes an inner layer including scent molecules; a middle layer disposed on the inner layer and including an ultra-micro-perforated filtering membrane; and an outer layer disposed on the outer layer.

In still another aspect, a sanitary mask includes an inner layer; an ultra-micro-perforated filtering membrane formed over the inner layer; an antibacterial layer formed over the ultra-micro-perforated filtering membrane; and an outer layer disposed on the antibacterial layer.

In yet another aspect, a sanitary mask includes an inner layer; a middle layer disposed on the inner layer; and an outer layer disposed on the middle layer and wherein the outer layer includes antibacterial ingredients, wherein the antibacterial ingredients include lysozyme or anti-influenza medicine.

### BRIEF DESCRIPTION OF THE DRAWINGS

FIG. 1 illustrates a device of the present invention;

FIG. 2 illustrates a manufacturing process of the present invention;

FIG. 3 illustrates a sanitary mask of the present invention;

FIG. 4 illustrates a spectral diagram of the UV absorption.

### DETAILED DESCRIPTION

Generally, a sanitary mask at least includes three layers including an inner layer, a middle layer as a filter layer and an outer layer. The sanitary mask of the present invention includes a substrate including the outer layer manufactured by the following process, so as to have UV protection function.

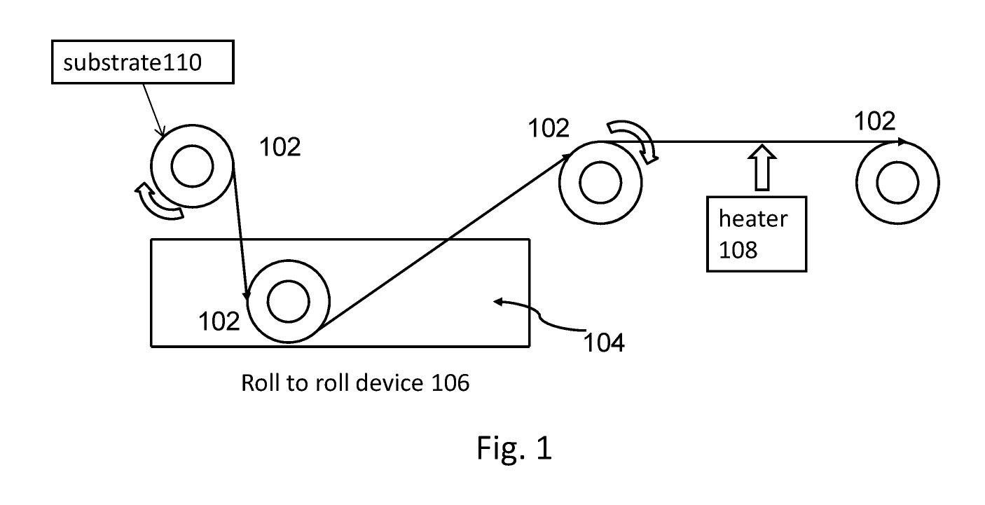

A roll to roll device 106 is configured such that the roll to roll device 106 at least includes three rolls 102, wherein at least one roll is disposed in a dipping tank 104. The dipping tank 104 is employed to be loaded with dye. The rolls 102 may be driven by driving devices such as motors, so as to render them to rotate around an axis of rotation respectively and tug the soft substrate to move for example as shown by the curved arrow in FIG. 1, such that the substrate 110 may be moved from one end to another end. During the process, the substrate 110 will be driven to move and pass through the dipping tank 104, where the anti-UV dye will be attached onto the substrate 110. The rotation speed of the rolls 102 may be controlled, thereby controlling the moving speed, so as to control the thickness of the material. The heating device 108 is correspondingly disposed below the horizontally moving substrate 110 and may be optionally actuated to provide heating source for the drying process. The heating device 108 may be lamp, hot blast, electromagnetic radiation or infrared ray heater.

As the manufacturing process progresses, the substrate is moved from one undipped end to another end. At this time, the dipped substrate will be moved to another end to be collected. The dipped substrate can be rolled at another end because the substrate is flexible. If necessary, the heating device may be actuated to provide the heat energy for the drying process. Then, the rolled substrate may be performed with subsequent processing to form the sanitary mask or other articles, such as anti-UV umbrella fabric, anti-UV shade fabric. If necessary, the soft substrate may be coated with a buffer layer or a protective layer.

The present invention may employ non-metal or non-metallic oxide materials as the anti-UV material to avoid environmental pollution. The flexible substrate may be utilized such that the material may be manufactured into thin films on large scale via the roll to roll device of the present invention and the manufacturing process will not pollute the environment. The rotation speed of the axis of rotation may be controlled to control the growth thickness of the thin film and render the thin film to be attached to irregular or uneven surfaces.

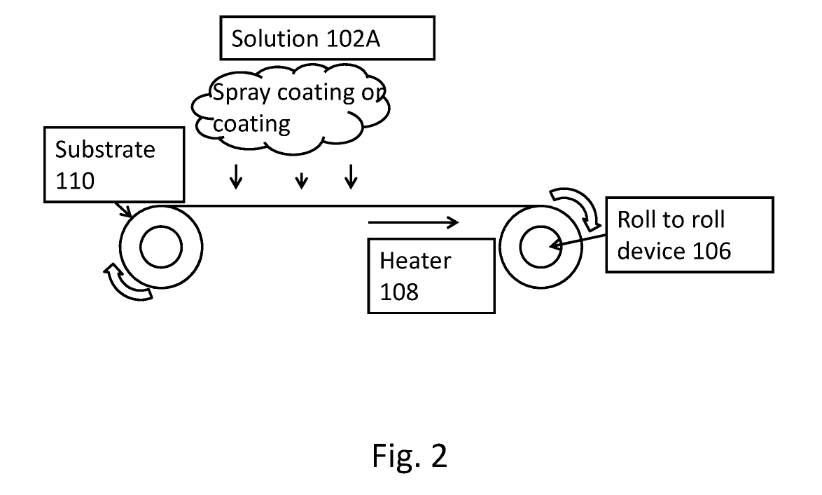

Please refer to FIG. 2 which shows one embodiment of the present invention. In this embodiment, the devices are similar to those in FIG. 1. The difference between this embodiment and the embodiment shown in FIG. 1 is that this embodiment employs coating, spray coating or inkjet printing to coat the desired soft substrate with the solution. After the solution is prepared, the inkjet printing, spray coating, printing or coating process may be performed to distribute the material onto the soft substrate. If the inkjet printing process is utilized, dye pattern may be printed onto the soft substrate directly and the remaining steps including optionally heating are similar to those in the previous embodiment.

The fabric surface of the anti-UV mask may be spray coated, dipped or coated with the anti-UV absorbent material or photochromic dye to achieve the anti-UV function. If the anti-UV coating is spray coated on the surface, the color change of the mask may be observed, thereby indicating the function of anti-UV. The traditional mask is not available to offer the anti-UV function, let alone observing the protective effect thereof. Actually, the traditional mask fails to provide any protection and thus is disadvantageous to the care after facial cosmetic surgery. The prevention from UV radiation is the most important procedure for the care after cosmetic surgery. Therefore, the present invention offers advantages of the skin care after cosmetic surgery. The traditional mask cannot achieve the aforementioned function at all.

The present invention dopes resin for example aqueous resin with the photochromic dye, and may mix the photochromic dye in the form of micro powders, capsules or liquid and the resin. For instance, the aqueous resin may be employed to mix with the hydrophilous photochromic dye to form the dip solution. The mixing ratio of the photochromic dye and the resin may be about 1:5 to about 1:20, wherein the dip solution may be diluted with water to adjust the viscosity thereof. The photochromic dye may absorb sunlight or ultraviolet radiation, and the chemical structure of the photochromic dye is changed after receiving the radiation. The photochromic dye can generate reversible chemical change after illuminated by the sunlight or UV radiation, thereby resulting in change of color. When not illuminated by the sunlight or UV light, the color of the mask changes back to the original color.

The photochromic dye may be optionally doped in the resin together with light stabilizer and UV absorber to assist in absorbing UV radiation. Adding antioxidant or/and UV absorber into the resin can enhance the anti-light fatigue. The photochromic dye may be, but be not limited to, spiropyrans, spiroxazines, fulgide, fulgimides, benzopyran, naphthopyran, spirobenzopyran, spironaphthopyran, spirobenzoxazine or spironaphthoxazine.

Synthetic fiber is monomer raw material obtained from nature and forms fiber by polymerization and fiber spinning. For example, condensation polymer: (A) polyamide fiber: Nylon 6, Nylon 6.6, Nylonll; (B) polyester fiber: PET, PBT, PTT; (C) addition polymer: (1) polyacrylonitrile fiber: PAN (also referred to as acrylic fiber); (2) polyethylene fiber: PE; (3) polypropylene fiber: PP; (4) polyvinylalcohol fiber: PVA; (5) polyvinylchloride fiber: PVC; (6) polytetrafluoroethylene fiber: PTFE; (7) polyurethane fiber: PU. Carbon fiber and glass fiber are classified as inorganic synthetic fiber. High functional fiber may include poly lactic acid, PBO fiber (p-phenylene-2,6-benzobisoxazole), high-tenacity polyester, polyamide, polyolefine, p-aromatic polyamide and meta-aromatic polyamide, carbon fiber, high-modulus polyethylene (HMPE), polyphenylene sulfide (PPS), phenlic fiber of polymer, polyether ether ketone (PEEK), P84, etc. The drying temperature may be below 150 degrees Celsius based on the choice of the photochromic dye and the processing temperature.

In another embodiment, the fusion process of the dye and the polymer may employ the following methods. For example, the melt spinning method: the photochromic material or color changeable material and the polymeric base material are melt spun, or the photochromic material is distributed in the resin carrier which can be mixed and melted in the spun polymer and is further mixed with polymer such as polyester, Nylon, polypropylene to perform melt spinning.

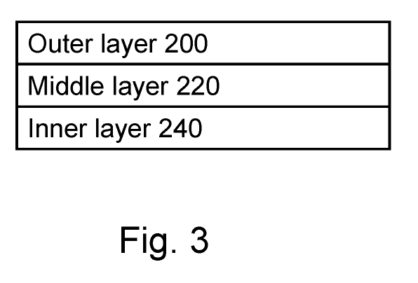

Therefore, please refer to FIG. 3, which illustrates a cross-sectional diagram of the mask of the present invention. The mask of the present invention may include three layers or four layers or more. This embodiment takes three layers as an example. The outer layer 200 is an anti-ultraviolet layer, the manufacturing method of which may refer to the aforementioned methods. The middle layer 220 may be a filter layer to filter out dust, bacteria, etc., and the inner layer 240 may be made of cotton fabric and may also be made of skin-friendly material for example ice silk cotton material or TPE, etc. The scent substrate may be manufactured in the inner layer via the aforementioned method. Scent, essence, essential oil, perfume raw material, etc. may be added into the substrate in the inner layer to obtain the scent substrate and enhance the effect. Lysozyme or degerming enzyme may be added into the outer layer or the middle layer by spray coating, dipping, coating or printing to eliminate bacteria. The traditional mask can only filter out bacteria and fails to kill bacteria. Therefore, the present invention can decompose bacteria with enzyme in addition to filtering. Furthermore, influenza virus lysozyme or degerming enzyme may also be added into the outer layer 200 or the middle layer 220 by spray coating, dipping, coating or printing to eliminate bacteria. The traditional mask can only filter out bacteria and fails to kill bacteria. Therefore, the present invention can decompose bacteria with enzyme in addition to filtering. Moreover, anti-virus medicine may also be attached to the outer layer 200 or the middle layer 220 by spray coating, dipping or coating to suppress the influenza virus, enterovirus, etc. The filtering layer 220 may employ an ultra-micro-perforated biotechnological filtering membrane (PTFE biotechnological membrane), which can filter out particles smaller than 0.1-2.5 micrometers to restrain the damage caused by PM 2.5, can have anti-haze function and is air-permeable, such that the user can breathe easily when wearing the sanitary mask. The nano-micro-perforated polytetrafluoroethylene (PTFE) membrane has aperture smaller than that of common micro-perforated membrane, and is highly hydrophobic and highly lipophobic, so as to have excellent moisture permeability, air permeability, water-proof property and oil-proof property. The PTFE nano-micro-perforated membrane (sub-micron-perforated filtering membrane) which can endure ultra-high water pressure and has ultra-high moisture permeability and air permeability is made of polytetrafluoroethylene material in ultra-highly crystalline state by being extruded into membranes under ultra-high pressure with extremely fast stretching speed, such that the membrane can have nano-micro-perforated three-dimensional structure with ultra-high strength. The aperture of the membrane may be controlled between 0.03 μm (30 nm) and 15 μm, the thickness of the membrane may be 8˜50 μm, and the porosity of the membrane may reach 80˜97%. The ultra-micro-perforated filtering membrane replaces the traditional unwoven fabric filtering layer with polymer membrane filtering material, and the filtration rate thereof reaches and is above 99.9%. The ultra-micro-perforated biotechnological filtering membrane can eliminate virus, allergen, fine and suspended particles in the air, is highly air-permeable and is not suffocating.

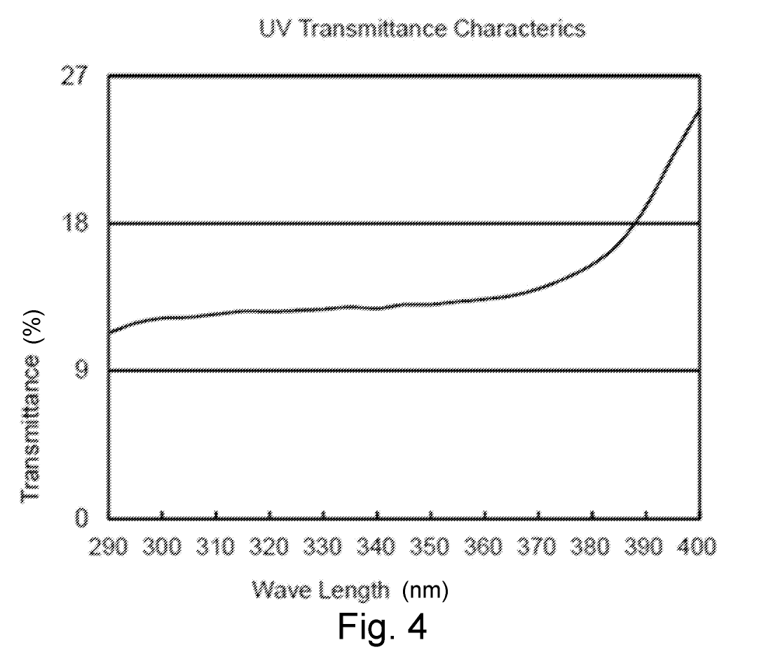

The ultraviolet radiation with a wavelength from 100 nm to 280 nm has shorter wavelength and stronger energy. The most harmful to the skin is UVC which is mostly isolated by ozone layer in atmospheric layer and almost fails to reach the ground. The UV radiation with a wavelength from 280 nm to 320 nm has lower energy than that of UVC and can induce immediate sunburn of the skin and cause skin cutin thickening, darker skin, erythrosis, conjuncitivitis, painful and drier skin, which are mainly because of UVB. FIG. 4 is a transmittance diagram of ultraviolet radiation. From FIG. 4, it can be seen that the UV radiation is mostly absorbed. For example, the transmittance of the UV radiation with a wavelength below 310 nm is below about 10%, which indicates that more than 90% of strong UV radiation is absorbed. The main reason is that the rate of gas exchange of the mask must fulfill related requirement and therefore the mask cannot be completely airtight. Thus, the amount of the UV radiation absorbed may need to be sacrificed and a compromise is employed because of the desired UV radiation absorption and the requirement of gas penetration. Therefore, it can be seen that the present solution can filter out the UV radiation with a wavelength below 310 nm having higher energy (the transmittance is below about 10%).

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the present invention. It is intended that all such modifications and alterations are included insofar as they come within the scope of the present invention as claimed or the equivalents thereof.

1. A method of manufacturing a mask, comprising:
preparing a roll-to-roll device including at least three rolls;
driving said at least three rolls with a driving device to move a substrate to pass through a tank with a material for attaching onto said substrate, wherein a process for attaching said material includes dipping, inkjet printing, spraying, printing or coating;
moving said substrate from one end to another end in order for said attached substrate to be rolled to and collected at another end; and
performing subsequent processing to said rolled substrate to form said mask.

2. The method of claim 1, further comprising controlling a rotation rate of said at least three rolls to control a moving rate of said substrate, so as to control a thickness or amount of said material.

3. The method of claim 1, further comprising correspondingly disposing a heating device at a side of said substrate to provide a heating source for drying said material.

4. The method of claim 3, wherein said heating device includes lamp, hot blast, electromagnetic radiation or infrared ray heater.

5. The method of claim 1, wherein said material includes UV absorbent, photochromic dye, resin or any combination thereof to form an outer layer of said mask.

6. The method of claim 1, wherein said material includes said ultra-micro-perforated filtering membrane to form a middle layer of said mask.

7. The method of claim 1, wherein said material includes antibacterial ingredients to form an outer layer of said mask.

8. The method of claim 7, wherein said antibacterial ingredients include lysozyme.

9. The method of claim 7, wherein said antibacterial ingredients include anti-influenza medicine.

10. The method of claim 6, wherein an aperture of said ultra-micro-perforated filtering membrane is between about 0.03 μm and about 15 μm.

11. (canceled)

12. The method of claim 6, wherein a thickness of said ultra-micro-perforated filtering membrane is about 8˜50 μm.

13. The method of claim 6, wherein said ultra-micro-perforated filtering membrane is polytetrafluoroethylene (PTFE).

14. The method of claim 1, wherein said material includes scent molecules to form an inner layer of said mask.

15.˜20. (canceled)
